(19) United States
(12) Patent Application Publication
(10) Pub. No.: US 2022/0247192 A1
(43) Pub. Date: Aug. 4, 2022

(54) CHARGING CRADLE FOR AT LEAST ONE ELECTRICAL DEVICE

(71) Applicant: Andreas MARTIN, München, DE (US)

(72) Inventor: Andreas MARTIN, München (DE)

(21) Appl. No.: 17/597,494

(22) PCT Filed: Jul. 8, 2020
(86) PCT No.: PCT/EP2020/000128

§ 371 Date: Jan. 7, 2022

(30) Foreign Application Priority Data
Jul. 8, 2019 (DE) 10 2019 004 793.1
Jul. 8, 2019 (DE) 20 2019 002 878.1

(51) Int. Cl. H02J 7/00

(52) U.S. Cl. CPC H02J 7/0044

(57) ABSTRACT

The invention relates to a charging cradle (1) for retaining, fixing and setting up an electrical connection to at least one electrical device (20) consisting of a stand-alone or integrated housing part, for example an instrument panel in the vehicle, and a movably mounted contact unit assembly (9, 9′) which facilitates the insertion and the fixing of the electrical device (20) by at least one device clamp (6), and also an electrical contact unit (2) in an assembly block (10) matching an electrical device contact adapter (22), connected to the electrical device contact unit (21), which is held so as to be movable in at least one degree of freedom (32) and to be vibration-damped by at least one holder (3). After the insertion of the device into the charging cradle, an air gap provided by design remains between the electrical contact unit (2) and the electrical device contact adapter (22) and this air gap is bridged and a contact is produced autonomously by the electrical contact unit (2) and/or the electrical device contact adapter (22) being magnetic or at least one being magnetic and the other ferromagnetic, and in the assembled final contact position the electrical contact unit (2) of the charging cradle (1) has no connection or a vibration-damped connection to the holder (3).

The invention relates to a charging cradle for at least one electrical device which has an element fixing the electrical device and a movably-mounted electrical contact unit suitable for the electrical device contact unit, and which automatically establishes the electrical contact after insertion of the electrical device.

Patent application EP 22 28 263 A1 discloses an invention in which a holder of an electrical device is provided, but the electrical connection must additionally be made manually.

Patent application DE10 2009 017 265 A1 discloses a device cradle in which, upon insertion of the electrical device, the electrical contact is also established by means of permanently-placed contacts.

Particularly in the case of asymmetrical sockets and plugs, such as, for example, Micro-USB 2.0, there is a high risk that, when the electrical connection is being established directly during placement of the electrical device in the charging cradle, the slightest deviation will lead to the socket and the plug being tilted and the forces acting there causing damage.

In utility model DE 20 2016 105 475 U1, an adapter for a universal electronic device cradle is described, wherein the plug is firmly fixed manually in the adapter in predefined positions, then remains in this position, and the contact is established manually at the same time when the electrical device is inserted. Individual distances between the charging cradle and the electrical device should be able to be compensated for here. Here, a rapid wear of the plug connectors is also to be expected, since there is no kind of guidance of the contacts.

Publications U.S. Pat. No. 5,931,683 A and US2011079701 A1 disclose a charging cradles, and US20140321049 A1 and CN207994182U, a docking station.

Even if the above-described charging cradles with contact units—here, mainly USB—are intended to simplify contact establishment between the electrical device and the charging cradle in different combinations, then, not only the insertion of the electrical device into the charging cradle, but also the plugging process—in particular, in the case of asymmetrical connections, such as Micro-USB—must be performed manually by hand exactly and with little play in the cradle.

If a device is inserted into the charging cradle with a tilting movement due to the design or location of its electrical contacts, a simultaneous connection of plug-socket contacts—in particular, in the case of asymmetrical, long, plug-in contacts, and in the case of a rigid positioning of these contacts—is virtually impossible.

In this regard, patent DE 10 2006 030 496 A1 shows the solution by means of coupling and adapters, wherein, here too, the electrical connection is to be established manually.

U.S. Pat. No. 7,477,039 B2 describes a charging cradle in which the positioning of the mobile electrical device in the charging tray by means of magnets is described, wherein the magnets and the electrical contact unit of the charging cradle are designed to not be movable.

This form of combination of automatic positioning and establishment of the electrical contact is possible only with exposed contact surfaces, and then only when the device itself, as in the above US patent, is movable freely and with a great deal of play in the charging tray, without any mechanical clamping. For this reason, this form of charging cradle in a vehicle is rather out of the question.

A rigid connection between the electrical contact unit of the charging cradle and the electrical device contact unit also leads to a transmission of vibrations, e.g., in a vehicle, which are transmitted to other electronic assemblies in the device and, in the extreme case, result in mechanical damage.

In addition, it also makes sense for devices with an elongated design or unfavorable center of gravity to be secured in the charging cradle in such a way that, for example, in the event of vibrations or acceleration of the vehicle, a secure hold is ensured, and the electrical contact is not interrupted.

The aim of this present invention is to design a charging cradle such that, after insertion into the charging cradle of the electrical device that is to be charged and fixed, the electrical contact between the contact unit and the device contact unit is effected autonomously, i.e., automatically, and, in this position, the electrical contact unit of the charging cradle is vibration-decoupled from the latter, and the device is, mechanically, securely fixed, e.g., in the case of strong vibrations, and thus, also, the permanent electrical contact is ensured.

This aim is achieved according to the invention by the charging cradle according to claims 1, 2, and 3 in that a contact unit assembly (9, 9′) that is movably mounted and installed in the charging cradle housing (14) facilitates the insertion and fixing of the electrical device (20) by at least one device clamp (6) and in that an electrical connection is established autonomously, i.e., automatically, and in a vibration-damped manner, in that the electrical device contact unit is connected to an electrical device contact adapter, e.g., via the standard Micro-USB plug connection, and this electrical device contact adapter in turn has exposed coupling contacts, e.g., spring contacts, matching the electrical contact unit of the charging cradle, and, after insertion of the electrical device, and reaching the device end position in the charging cradle between the electrical contact unit of the charging cradle, which is magnetic and/or at least ferromagnetic, and the electrical device contact adapter, which is magnetic, an air gap provided by design is automatically bridged by the magnetic attraction force, wherein the electrical contact unit of the charging cradle including cable is held in at least one holder in a movable manner with up to six degrees of freedom in such a way that no greater or additional mechanical force is required than the magnetic attraction force available for establishing and maintaining the mechanical and electrical connection between the electrical contact unit of the charging cradle and the electrical device contact adapter, and that at least one mechanical device cradle of the charging cradle holds the device in its position.

Between the electrical contact unit, which is movably mounted in a holder of the charging cradle, the mechanical connection to the opposite electrical device contact unit of the previously-used electrical device is automatically effected by means of an electrical device contact adapter which is magnetic and has a magnetic attraction force sufficiently strong to thereby establish and maintain the mechanical and electrical connection between the charging cradle and the device.

Magnetic USB cables with an electrical contact unit with open coupling contacts and a matching electrical device contact adapter with standard connections such as are usual on the market, e.g., Micro-USB, are already available commercially and are in particular available for use even with low production volumes of charging cradles.

This basically allows charging cradles according to claims 1, 2, and 3 to be implemented for already-existing devices, e.g., with Micro-USB connections, as in the case of the thermal-imaging camera of the Reveal type from the US company, Seek Thermal, in which the Micro-USB socket with its internal contacts in addition lies even deeper in a bay of the device, and the housing shape is curved.

If, in the case of a new development of an electrical device, the electrical device contact unit is already designed with exposed, flat coupling contacts matching the electrical contact unit of the charging cradle and is magnetic, it will be possible to dispense with the electrical device contact adapter.

In the exemplary case of the charging cradle for the Reveal thermal-imaging camera with Micro-USB connection, a commercially available, magnetic USB cable with electrical contact unit and matching magnetic Micro-USB device contact adapter is used, wherein the electrical contact unit equipped with a cable is fixed in an assembly block of the charging cradle. This assembly block can be adapted individually in order to use cables of various manufacturers.

One contact unit per charging cradle forms the contact unit assembly with one assembly block—in one embodiment, with two bridging arms, two lateral holders, and the device receiving surface with contact through-opening. This contact unit assembly is seated fixed in the charging cradle housing via the lateral holder and a charging cradle cover.

In order that the air gap, provided by design, between the device contact unit and the electrical contact unit in the charging cradle can be overcome exclusively via the magnetic attraction force, the assembly block with the contact unit is held movably, for example, by two bridging arms in two lateral holders, each with a groove.

The grooves are ideally dimensioned such that, after the electrical connection is established via the lateral holders, the bridging arms no longer have any contact with the charging cradle and thus vibrations cannot be transmitted, and mechanical damage to the electrical connection between device and charging cradle due to the application of force from the outside is avoided.

However, vibration-damping of the electrical contact unit can also be realized by a spring-elastic design of the bridging arm, wherein this is then fixed, for example, on the lateral holders without play, and the mobility of the contact unit comes about of itself due to the bridging arms.

The assembly block of the electrical contact unit can also be designed in the form of a geometric body, e.g., as a cone, cylinder, spherical, as a cone or pyramid, and lie movably with up to six degrees of freedom in a holder, in each case matching geometrically—optionally, also as a hollow body—positioned directly below the contact through-opening in the device receiving surface.

In any case, it must be ensured, irrespective of whether the electrical contact unit of the charging cradle is held laterally by means of bridging arms or lies below the contact through-opening via a geometrically-shaped assembly block, that, after the electrical device has been removed, the electrical contact unit of the charging cradle detaches from the electrical device contact unit only by breaking the magnetic adhesion, and the electrical contact unit falls back into the holder of the charging cradle and into its starting position, and that, at the next insertion of the electrical device, it once again lies appropriately opposite the electrical device contact adapter.

The return of the universal electrical contact unit into the holder of the charging cradle can also be supported by an elastic return component, e.g., by an elastic charging and data cable, fixed in the charging cradle housing via a strain relief device.

At least one spring component is required to make a contact unit assembly movable, which simplifies insertion, but also removal, of the electrical device from the charging tray—in particular, when at least one device cradle fixes the device in the charging cradle.

The use of a spring component, which, in one possible embodiment, also takes on the function of the holder for an electrical contact unit or its assembly block in cylindrical form, represents a further variant.

A holder whose integral component is a spring component is another variant.

Exemplary embodiments are explained below with reference to the following figures:

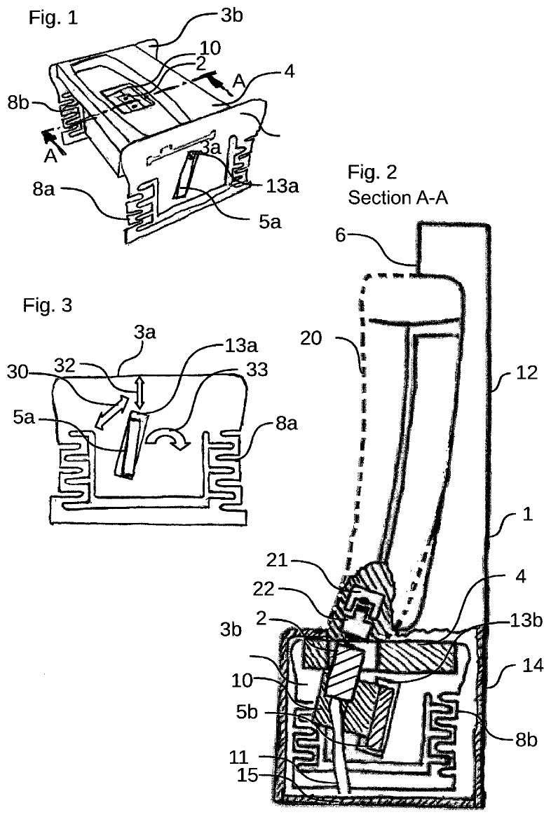

FIG. 1 shows a perspectival view of the essential mechanical structure of a first exemplary embodiment. The illustrated contact unit assembly (9) consists of device receiving surface with contact through-opening (4), two lateral holders (3a, 3b) each having a groove (13a, 13b), two bridging arms (5a, 5b), which are mirror-symmetrical in relation to each other but not visible in the figure, and an assembly block (10) with a contact unit (2).

The grooves (13a, 13b) are larger in their dimensions than the two bridging arms (5a, 5b), thereby resulting in play. In this exemplary embodiment, the spring components (8a, 8b) have been integrated as part of the lateral holders (5a, 5b).

FIG. 2 shows the first exemplary embodiment of the charging cradle (1) according to the invention in a side view with the contact unit assembly (9) in the charging cradle housing (14) shown as partial section A-A.

To be seen in detail are the device receiving surface with contact through-opening (4), lateral holder (3b) with groove (13b) and integrated spring component (8b), bridging arm (5b) and an assembly block (10) with a contact unit (2) and cable (11) in the charging cradle housing (14) with charging cradle cover (15). In the upper part, the device (20) is shown by a dashed line with device contact unit (21) and device contact adapter (22) in the charging cradle (1) with device cradle (6) and rear wall (12).

FIG. 3 again shows, for the first embodiment, the holder (3a) with integrated spring component (8a), the groove (3a) in which the bridging arm (5a) is held with sufficient play and the exemplary degrees of freedom of up/down (30), forward/back (32), and tilt (33).

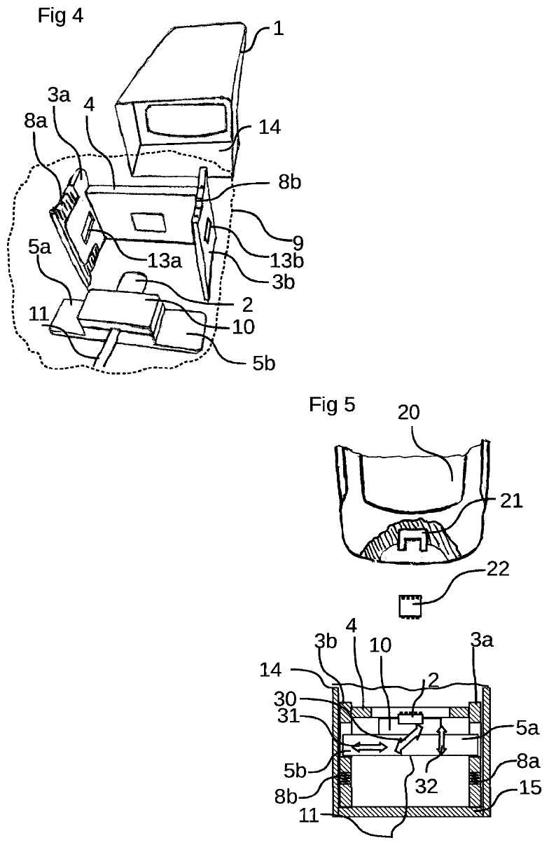

FIG. 4 shows the first exemplary embodiment in perspective from below. In the background, charging cradles (1) with charging cradle housing (14). In the foreground, the contact unit (2) with cable (11) in the assembly block (10) and two bridging arms (5a, 5b) and, behind it, the device receiving surface with contact through-opening (4), lateral holder (3a, 3b) with groove (13a, 13b) and integrated spring component (8a, 8b) together form the contact unit assembly (9).

FIG. 5 shows the first exemplary embodiment once again as a schematic representation in a front view with device (20) and device contact unit (21), the device contact adapter (22), charging cradle housing (14) with flush-mounted device receiving surface with contact through-opening (4), lateral holder (3a, 3b) with groove (13a, 13b) and integrated spring component (8a, 8b), bridging arm (5a, 5b) with assembly block (10), comprising contact unit (2) and cable (11), with the exemplary degrees of freedom up/down (30), forward/back (32), and tilt (33), and the charging cradle cover (14).

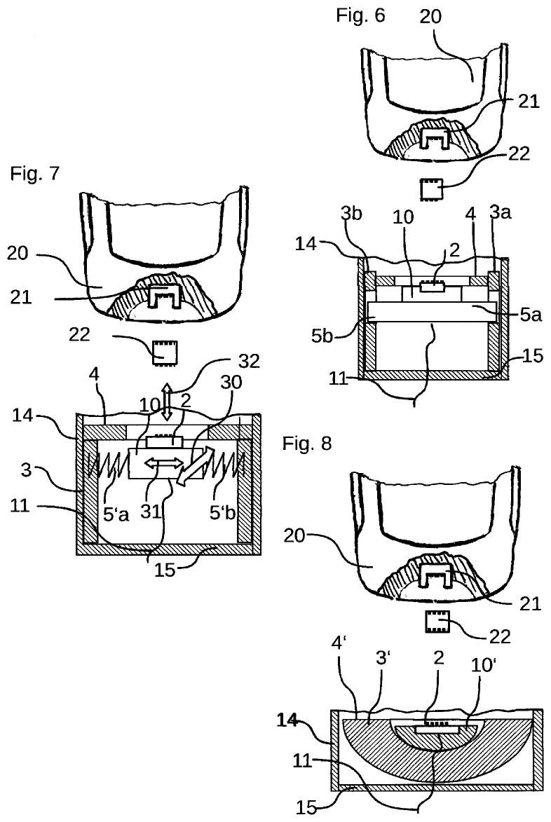

FIG. 6 shows the second exemplary embodiment in a front view as a three-part, schematic representation; Part 1 with device (20) and device contact unit (21), Part 2 as device contact adapter (22), and Part 3 as a charging cradle housing (14) with charging cradle cover (15) in section with built-in device receiving surface with contact through-opening (4), both holders (3a, 3b) without integrated spring components, in which the electrical contact unit (2) with cable (11) is held with at least one degree of freedom in an assembly block (10) by means of two bridging arms (5a, 5b).

FIG. 7 shows, in a third exemplary embodiment, in a front view as a three-part representation, the electrical contact unit (2) with cable (11) in an assembly block (10) which, by means of vibration-damped, spring-elastic bridging arms (5′a, 5′b), is held movably by two lateral holders (3a, 3b) and sits flush in the charging cradle housing (14) with charging cradle cover (15). The degrees of freedom forward/back (30), left/right (31), and up/down (32) are shown by way of example. The device (20) is shown with device contact unit (21) and, in addition, the device contact adapter (22).

FIG. 8 shows, in a fourth exemplary embodiment, in a front view, a schematic representation of the holder (3′) in the form of a geometric body in which the electrical contact unit (2) with cable (11) is movably mounted in an assembly block (10) geometrically matching the geometric body with at least one degree of freedom. In this exemplary embodiment, the device (20) sits with the device contact unit (21) directly on the holder (3′), which simultaneously represents the device receiving surface with contact through-opening (4′). The holder (3′) sits flush in the charging cradle housing (14) with charging cradle cover (15).

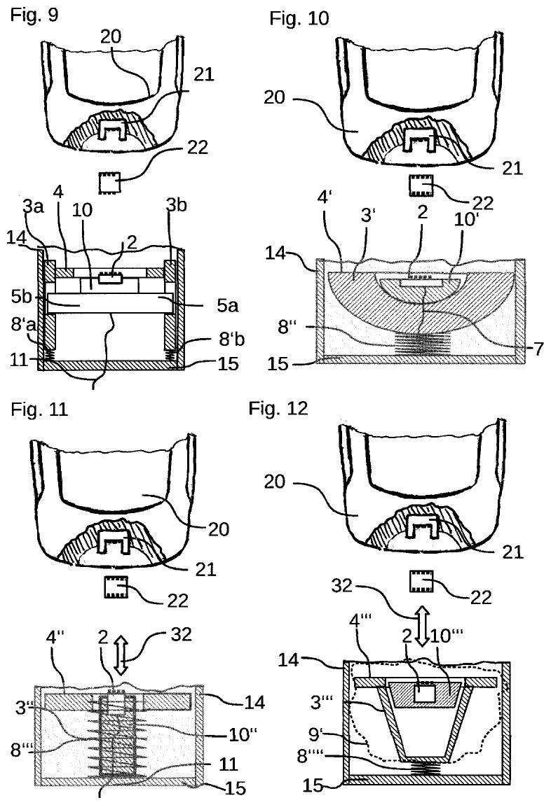

FIG. 9 shows, in a fifth exemplary embodiment, in a front view, the schematic representation the lateral holders (3a, 3b) movably seated on spring components (8′a, 8′b), in which the bridging arm (5a, 5b) of the assembly block (10) with the electrical contact unit (2) with cable (11) is also held movably below the device receiving surface with contact through-opening (4) and sits flush in the charging cradle housing (14) with charging cradle cover (15). In addition, in the illustration, the device (20) with contact unit (21) and device contact adapter (22).

FIG. 10 shows, in a sixth exemplary embodiment, in a front view as a three-part representation, the holder (3′) in the form of a geometric body, whose surface facing the device (20) with device contact unit (21) and device contact adapter (22) serves at the same time as a device receiving surface with contact through-opening (4′) and in which the electrical contact unit (2) is held movably with at least one degree of freedom in the assembly block (10′) geometrically matching the holder (3′) with an elastic return component (7) and which sits movably in the charging cradle housing (14) with charging cradle cover (15) by means of a spring component (8″).

FIG. 11 shows, in a seventh exemplary embodiment in a front view, the three-part representation with the device receiving surface with contact through-opening (4″) and also the spring component (8′), which, with its geometrical shape, at the same time takes on the task of the holder (3″) for the cylindrical assembly block (10″) with the electrical contact unit (2) with cable (11), and has at least one degree of freedom up/down (32) and sits in the charging cradle housing (14) with charging cradle cover (15).

FIG. 12 shows, in an eighth exemplary embodiment in a front view as a three-part representation, the contact unit assembly (9′), which is movably mounted by means of a spring element (8″) and consists of holder (3′″) in the exemplary geometrical shape of a hollow cone in the matching conical assembly block (10′″) with the electrical contact unit (2), and sits movably below the device receiving surface with contact through-opening (4′″).

According to the invention, in all exemplary embodiments, an electrical connection is established automatically and vibration-damped in that, after insertion of the electrical device (20) into the charging cradle (1), an air gap, provided by design, between the electrical contact unit (2) and the electrical device contact adapter (22) or, in the case of new devices, also the electrical device contact unit (21) is bridged by the electrical contact unit (2) and/or the electrical device contact adapter (22) or the electrical device contact unit (21) being magnetic, or the respective counterpart to the magnetic being at least ferromagnetic, wherein the electrical contact unit (2) in the charging cradle (1) is movably held in at least one holder (3) in such a way that no greater or additional mechanical force is required than the available magnetic attraction force in order to establish and maintain the mechanical and electrical connection between the contacts, and at least one device clamp (6) holds the device in position.

A movably-mounted—as illustrated in FIGS. 4 and 12—contact unit assembly (9, 9′) installed in the charging cradle housing (14) facilitates the insertion and fixing of the electrical device (20) by means of at least one device clamp (6).

This movable contact unit assembly (9, 9′) consists of a device receiving surface with contact through-opening (4, 4′″), at least one holder (3, 3′″), and an electrical contact unit (2) with cable (11) in an assembly block (10′″), and is mounted movably in the charging cradle housing (14) via at least one spring component (8, 8″″) so that, upon insertion of the electrical device with pressure on the device receiving surface with contact through-opening (4, 4′″), this, including the electrical contact unit (2), yields, whereby the electrical device (20) is pushed into its final position by the restoring force of the contact unit assembly (9, 9′) and is held by the device clamp (6), and the contact between the electrical contact unit (2) and electrical device contact unit (21) is automatically established by the magnetic attraction force.

FIGS. 1 through 5 and 9 through 12 show, for example, different designs of the spring component, which, although having the same reference number 8, have different indices, such as 8′, 8″, 8′″, and 8″″.

As shown in the embodiment according to FIGS. 1 through 5, the spring component (8) is integrated as part of the holder (3).

One way of damping the transmission of vibrations from the charging cradle (1) to the electrical contact unit (2), and thus to the electrical device contact unit (21), is for the electrical contact unit (2) of the charging cradle (1) to be movably vibration-decoupled from the holder (3) by at least one degree of freedom.

FIG. 7 shows a further possibility by means of two, spring-elastic bridging arms (5′a, 5′b) which are designed to be movable in a vibration-damped manner between the electrical contact unit (2) and the holder (3).

If an electrical device (20) is newly developed, the electrical device contact unit (21) and the electrical contact unit (2) of the charging cradle (1) can be selected to match each other in such a way that an electrical device contact adapter (21) can be dispensed with.

The functionality of this charging cradle (1) can be implemented as a stand-alone housing for one or more electrical devices (20) or can be an integral part of a modular or functional component—for example, a dashboard in the vehicle.

### LIST OF REFERENCE SIGNS (FORMS PART OF THE DESCRIPTION)

Charging cradle (1)
Electrical contact unit (2)
Holder (3, 3a, 3b, 3′, 3″, 3′″)
Device receiving surface with contact through-opening (4)
Bridging arms (5, 5a, 5b, 5′a, 5′b)
Device clamp (6)
Elastic return component (7)
Spring component (8, 8a, 8′a, 8b, 8′b, 8″, 8′″, 8″″)
Contact unit assembly (9, 9′)
Assembly block (10, 10′, 10″, 10′″)
Cable (11)
Rear wall (12)
Groove (13, 13a, 13b)
Charging cradle housing (14)
Charging cradle cover (15)
Electrical device (20)
Electrical device contact unit (21)
Electrical device contact adapter (22)
Degree of freedom back/forward (30)
Degree of freedom left/right (31)
Degree of freedom up/down (32)
Degree of freedom tilt left/right (33)

### LIST OF REFERENCE SKINS

Charging cradle (1)
Electrical contact unit (2)
Holder (3, 3a, 3b, 3′, 3″, 3′″)
Device receiving surface with contact through-opening (4)
Bridging arms (5, 5a, 5b, 5′a, 5′b)
Device clamp (6)
Elastic return component (7)
Spring component (8, 8a, 8′a, 8b, 8′b, 8″, 8′″, 8″″)
Contact unit assembly (9, 9′)
Assembly block (10, 10′, 10″, 10′″)
Cable (11)
Rear wall (12)
Groove (13, 13a, 13b)
Charging cradle housing (14)
Charging cradle cover (15)
Electrical device (20)
Electrical device contact unit (21)
Electrical device contact adapter (22)
Degree of freedom back/forward (30)
Degree of freedom left/right (31)
Degree of freedom up/down (32)
Degree of freedom tilt left/right (33)

1. Charging cradle (1) for retaining at least one electrical device (20) and supplying electrical energy and data thereto, wherein the charging cradle per electrical device (20) consists of at least one device clamp (6) and a charging cradle housing (14), and, in this charging cradle housing, a movably-mounted contact unit assembly (9, 9′) is installed, whereby the insertion and fixing of the electrical device (20) is facilitated by at least one device clamp (6),
characterized in that
this movable contact unit assembly (9, 9′), consisting of a device receiving surface with contact through-opening (4, 4′″), two lateral holders (3a, 3b) each having a groove (13a, 13b), and an electrical contact unit (2) with cable (11) in an assembly block (10′″), is movably mounted in the charging cradle housing (14) via two spring components (8a, 8b) in such a way
that, upon insertion of the electrical device with pressure on the device receiving surface with contact through-opening, said surface, including the electrical contact unit (2), yields, whereby the electrical device (20) is pushed by the restoring force of the contact unit assembly (9, 9′) into its final position and is held by the device clamp (6),
that, via two bridging arms (5a, 5b), the assembly block (10) with the electrical contact unit (2) and its cable (11) connected to a power supply is held movably with up to six degrees of freedom (30, 31, 32, 33) in each case in a groove (13a, 13b) of the two lateral holders (3a, 3b), wherein these degrees of freedom in the lateral holders (3a, 3b) are made possible by the two grooves (13a, 13b),
that, after insertion of the electrical device (20) into the charging cradle housing (14), an electrical device contact adapter (22) connected to the device contact unit (21) arranged on the electrical device (20) lies opposite this electrical contact unit (2) in such a way that an air gap provided by design is formed between the electrical contact unit (2) and the electrical device contact adapter (22),
and that, for each electrical device (20), the electrical contact unit (2) and the electrical device contact adapter (22) are preferably magnetic, or one part thereof is magnetic and the other part is ferromagnetic, so that, when the device (20) is inserted, the air gap is bridged by magnetic attraction, whereby the electrical contact is established automatically, and the electrical contact unit (2) in this position has no contact or a vibration-damped contact with the lateral holders (3a, 3b) and is thus vibration-decoupled from the charging cradle (1).

2. Charging cradle for retaining at least one electrical device (20) and supplying electrical energy and data thereto, wherein the charging cradle per electrical device (20) consists of at least one device clamp (6) and a charging cradle housing (14), and, in this charging cradle housing, a movably-mounted contact unit assembly (9, 9′) is installed, whereby the insertion and fixing of the electrical device (20) is facilitated by at least one device clamp (6),
characterized in that
this movable contact unit assembly (9, 9′), consisting of a device receiving surface with contact through-opening (4, 4′″), two lateral holders (3a, 3b), and an electrical contact unit (2) with cable (11) in an assembly block (10′″), is movably mounted in the charging cradle housing (14) via two spring components (8a, 8b) in such a way
that, upon insertion of the electrical device with pressure on the device receiving surface with contact through-opening, said surface, including the electrical contact unit (2), yields, whereby the electrical device (20) is pushed by the restoring force of the contact unit assembly (9, 9′) into its final position and is held by the device clamp (6),
that, via two spring-elastic bridging arms (5′a, 5′b), the assembly block (10) with the electrical contact unit (2) and its cable (11) connected to a power supply is held movably with up to six degrees of freedom (30, 31, 32) at the two lateral holders (3, wherein these degrees of freedom in the lateral holders) are made possible by the spring-elastic bridging arms (5′a, 5′b) fixed on the holders (3),
that, after insertion of the electrical device (20) into the charging cradle housing (14), an electrical device contact adapter (22) connected to the device contact unit (21) arranged on the electrical device (20) lies opposite this electrical contact unit (2) in such a way that an air gap provided by design is formed between the electrical contact unit (2) and the electrical device contact adapter (22).

3. Charging cradle for retaining at least one electrical device (20) and supplying electrical energy and data thereto, wherein the charging cradle per electrical device (20) consists of at least one device clamp (6) and a charging cradle housing (14) and, in this charging cradle housing, a movably-mounted contact unit assembly (9, 9′) is installed, whereby the insertion and fixing of the electrical device (20) is facilitated by at least one device clamp (6),
characterized in that
this movable contact unit assembly (9, 9′), consisting of a device receiving surface with contact through-opening (4, 4′″), a holder (3′, 3″, 3′″) in the form of a round or angular, geometric—preferably symmetrical—body—optionally, also of a hollow body or part thereof—e.g., as a hemisphere, cone, cylinder, pyramid, cone, or polygonal body, and an electrical contact unit (2) with cable (11) in an assembly block (10′″), which is in each case designed geometrically to match the geometrical shape of the holder and has up to six degrees of freedom (32),
that, upon insertion of the electrical device with pressure on the device receiving surface with contact through-opening, said surface, including the electrical contact unit (2), yields, whereby the electrical device (20) is pushed by the restoring force of the contact unit assembly (9, 9′) into its final position and is held by the device clamp (6),
that the assembly block (10′, 10″, 10′″) in each case geometrically matching the geometrical shape of the holder (3′, 3″, 3′″) in the form of a round or angular, geometric—preferably symmetrical—body—optionally, also of a hollow body or part thereof—e.g., as a hemisphere, cone, cylinder, pyramid, cone, or polygonal body, with the electrical contact unit (2) and its cable (11) with a power supply connected, is held movably with up to six degrees of freedom (32), wherein these degrees of freedom are made possible by this holder (3′, 3″, 3′″),
that, after insertion of the electrical device (20) into the charging cradle housing (14), an electrical device contact adapter (22) connected to the device contact unit (21) arranged on the electrical device (20) lies opposite this electrical contact unit (2) in such a way that an air gap provided by design is formed between the electrical contact unit (2) and the electrical device contact adapter (22).

4. Charging cradle according to claim 3 characterized in that the charging cradle (1) has a contact unit assembly (9) consisting of a device receiving surface with contact through-opening (4), a holder (3), and the assembly block (10) with the electrical contact unit (2) with cable (11), wherein this contact unit assembly (9) is movably connected to the charging cradle (1) via a spring component (8, 8a, 8′a, 8b, 8′b, 8″, 8′″, 8″″).

5. Charging cradle according to claims 1 and 3, characterized in that the spring component (8a, 8b, 8′″) is a structural—in particular, integrated—part of the holder (3a, 3b, 3″).

6. Charging cradle according to claim 3, characterized in that the holder (3) is so designed that it also performs the function of the device receiving surface with contact through-opening (4) and/or the function of the spring component (8).

7. Charging cradle according to claims 1, 2, and 3, characterized in that the electrical contact unit (2) of the charging cradle (1) and the electrical device contact unit (21) of a newly-developed electrical device (20) are designed to match each other in such a way that a device contact adapter (22) is not required.

8. Charging cradle according to claims 1, 2, and 3, characterized in that the contact unit (2) is a structural—in particular, integrated—part of the assembly block (10).

9. Charging cradle according to claim 3, characterized in that the return of the electrical contact unit (2) into the holder (3) is supported by the restoring force of an elastic return component (7), e.g., by an elastic charging and data cable fixed in the charging cradle housing by means of a strain relief device.

10. Charging cradle according to claims 1, 2, and 3, characterized in that at least one device clamp (6) per electrical device (20) is designed to be movable—preferably in a spring-elastic manner.
